(19) United States
(12) Patent Application Publication
(10) Pub. No.: US 2026/0231870 A1
(43) Pub. Date: Aug. 13, 2026

(54) GROWTH STATE ESTIMATION APPARATUS, PLANT MANAGEMENT SYSTEM, GROWTH STATE ESTIMATION METHOD, PLANT MANAGEMENT METHOD, AND PROGRAM

(71) Applicant: Yokogawa Electric Corporation, Tokyo (JP)

(72) Inventors: Emiko HATSUGAI, Tokyo (JP); Junshan WANG, Tokyo (JP); Hirari SATOU, Tokyo (JP)

(21) Appl. No.: 19/151,602

(22) PCT Filed: Mar. 6, 2024
(86) PCT No.: PCT/JP2024/008514

§ 371 Date: Jul. 28, 2025

(30) Foreign Application Priority Data
Mar. 24, 2023 (JP) 2023-047531

(51) Int. Cl. A01G 9/26; A01G 9/24; A01G 31/06

(52) U.S. Cl. CPC A01G 9/26; A01G 9/246; A01G 9/247; A01G 31/06

(57) ABSTRACT

A growth state estimation apparatus comprises a concentration acquisition unit which acquires a carbon dioxide concentration at a first time point in a plant factory and a carbon dioxide concentration at a second time point after the first time point, detected by a sensor provided in the plant factory, a supply amount acquisition unit which acquires a supply amount of carbon dioxide supplied from the first time point to the second time point in the plant factory via carbon dioxide supply equipment having a tank for storing carbon dioxide, a consumption amount identification unit which identifies a consumption amount of carbon dioxide consumed by a plant being cultivated in the plant factory from the first time point to the second time point, and an estimation unit which estimates a growth state of the plant.

The contents of the following patent application(s) are incorporated herein by reference: NO. 2023-047531 filed in JP on Mar. 24, 2023.

### BACKGROUND

### 1. Technical Field

The present invention relates to a growth state estimation apparatus, a plant management system, a growth state estimation method, a plant management method, and a program.

### 2. Related Art

Patent document 1 describes “performing, with a laser scanner 4, a scan using a pulsed distance measuring light with two wavelengths having different reflectances relative to nitrogen contents; separating the two wavelengths and receiving the separated lights; detecting a distance measurement value and a light amount for each pulsed distance measuring light and for each of the two wavelengths; detecting height of a crop based on the distance measurement value; detecting a received light amount ratio for the two wavelengths; and detecting growth states of the crop based on the detected height and the received light amount ratio”.

### RELATED ART DOCUMENTS

### Patent Documents

Patent Document 1: Japanese Patent Application Publication No. 2022-054395

### GENERAL DISCLOSURE

It is desired to identify a growth state of a plant cultivated in a plant factory while suppressing additional equipment.

A growth state estimation apparatus according to an aspect of the present invention may comprise a concentration acquisition unit which acquires a carbon dioxide concentration at a first time point in a plant factory and a carbon dioxide concentration at a second time point after the first time point, detected by a sensor provided in the plant factory. The growth state estimation apparatus may comprise a supply amount acquisition unit which acquires a supply amount of carbon dioxide supplied from the first time point to the second time point in the plant factory via carbon dioxide supply equipment having a tank for storing carbon dioxide. The growth state estimation apparatus may comprise a consumption amount identification unit which identifies a consumption amount of carbon dioxide consumed by a plant being cultivated in the plant factory from the first time point to the second time point, based on the carbon dioxide concentration at the first time point, the carbon dioxide concentration at the second time point, and the supply amount of carbon dioxide. The growth state estimation apparatus may comprise an estimation unit which estimates a growth state of the plant based on relationship information indicating relationship between the consumption amount of carbon dioxide and the growth state of the plant in the plant factory, and the consumption amount identified. The plant may be vegetable, fruit, or a fresh flower. The plant may be at least one of vegetable, fruit, or a fresh flower. The growth state may be a state obtained by dividing the growth state from planting to harvesting of the plant into a plurality of steps. The relationship information may be information divided in a step-wise manner to indicate that the larger the consumption amount of carbon dioxide is, the further the growth state of the plant has progressed.

In the growth state estimation apparatus, the consumption amount identification unit may identify a consumption amount of carbon dioxide consumed by the plant in the plant factory from the first time point to the second time point, further based on a predetermined basic consumption amount which is a consumption amount of carbon dioxide consumed in the plant factory during a period corresponding to a period from the first time point to the second time point without the plant being cultivated in the plant factory.

In any of the growth state estimation apparatus, the consumption amount identification unit may identify a discharge amount of carbon dioxide discharged by people from the first time point to the second time point, based on a number and staying time of people existing in the plant factory between the first time point to the second time point, and identifies a consumption amount of carbon dioxide consumed by the plant in the plant factory from the first time point to the second time point, further based on the discharge amount of carbon dioxide by people identified.

In any of the growth state estimation apparatus, the supply amount acquisition unit may acquire a supply amount of nutrient solution containing a fertilizer component that is supplied, via nutrient solution supply equipment having a tank for storing the nutrient solution, to the plant from the first time point to the second time point. The estimation unit may estimate the growth state of the plant based on relationship information indicating relationship between the supply amount of the nutrient solution and the growth state of the plant, and the supply amount of the nutrient solution. The estimation unit may estimate the growth state of the plant based on the growth state of the plant estimated based on the consumption amount of the carbon dioxide, and the growth state of the plant estimated based on the supply amount of the nutrient solution.

In any of the growth state estimation apparatus, when the growth state of the plant estimated based on the consumption amount of the carbon dioxide and the growth state of the plant estimated based on the supply amount of the nutrient solution match, the estimation unit may use the growth state that has matched as a growth state of the plant for controlling environmental control equipment which controls environment in the plant factory.

In any of the growth state estimation apparatus, when the growth state of the plant estimated based on the consumption amount of the carbon dioxide and the growth state of the plant estimated based on the supply amount of the nutrient solution do not match, the estimation unit may not use the growth state that did not match as a growth state of the plant for controlling environmental control equipment which controls environment in the plant factory.

The growth state estimation apparatus according to an aspect of the present invention may comprise a supply amount acquisition unit which acquires a supply amount of nutrient solution containing a fertilizer component that is supplied, via nutrient solution supply equipment having a tank for storing the nutrient solution, to a plant cultivated in a plant factory from a first time point to a second time point after the first time point. The growth state estimation apparatus may comprise an estimation unit which estimates a growth state of the plant based on relationship information indicating relationship between the supply amount of the nutrient solution and the growth state of the plant, and the supply amount of the nutrient solution.

The plant management system according to an aspect of the present invention may comprise the growth state estimation apparatus, and an environment control unit which controls environmental control equipment which controls environment in the plant factory such that the growth state of the plant estimated by the estimation unit becomes a predetermined growth state to be satisfied at the second time point.

In the plant management system, the environmental control equipment may include nutrient solution supply equipment which supplies nutrient solution containing a fertilizer component to the plant. The environment control unit may adjust a fertilizer concentration of the nutrient solution supplied to the plant by the nutrient solution supply equipment, such that the growth state of the plant estimated by the estimation unit becomes a predetermined growth state to be satisfied at the second time point. The environment control unit may adjust the fertilizer concentration of the nutrient solution supplied to the plant by the nutrient solution supply equipment to be increased, when the growth state of the plant estimated by the estimation unit has not reached the predetermined growth state to be satisfied at the second time point. The environment control unit may adjust the fertilizer concentration of the nutrient solution supplied to the plant by the nutrient solution supply equipment to be reduced, when the growth state of the plant estimated by the estimation unit has exceeded the predetermined growth state to be satisfied at the second time point.

In any of the plant management system, the environmental control equipment may include irrigation equipment which supplies water to a medium in which the plant is being cultivated. The environment control unit may adjust an amount of irrigation to the medium by the irrigation equipment, such that the growth state of the plant estimated by the estimation unit becomes a predetermined growth state to be satisfied at the second time point.

In any of the plant management system, the environmental control equipment may include light source equipment having a light source which radiates artificial light onto the plant.

The environment control unit may adjust an amount and irradiation time of the light radiated to the plant by the light source equipment, such that the growth state of the plant estimated by the estimation unit becomes a predetermined growth state to be satisfied at the second time point.

The environment control unit may increase the amount of light radiated to the plant by the light source equipment or extend the irradiation time of light to the plant by the light source equipment, if the growth state of the plant estimated by the estimation unit has not reached the predetermined growth state to be satisfied at the second time point. The environment control unit may reduce the amount of light radiated to the plant by the light source equipment or shorten the irradiation time of light to the plant by the light source equipment, when the growth state of the plant estimated by the estimation unit has exceeded the predetermined growth state to be satisfied at the second time point.

Any of the plant management system may further comprise a notification unit which sends a message indicating abnormality occurrence in the environmental control equipment when the consumption amount of carbon dioxide identified by the consumption amount identification unit is less than a predetermined threshold. The notification unit may send the message to an administrator who manages the plant factory. The notification unit may display the message on a display included in the plant management system. The notification unit may send the message to a terminal possessed by an administrator who manages the plant factory.

A growth state estimation method according to an aspect of the present invention may comprise acquiring a carbon dioxide concentration at a first time point in a plant factory and a carbon dioxide concentration at a second time point after the first time point, detected by a sensor provided in the plant factory. The growth state estimation method may comprise acquiring a supply amount of carbon dioxide supplied from the first time point to the second time point in the plant factory via carbon dioxide supply equipment having a tank for storing carbon dioxide. The growth state estimation method may comprise identifying a consumption amount of carbon dioxide consumed by a plant being cultivated in the plant factory from the first time point to the second time point, based on the carbon dioxide concentration at the first time point, the carbon dioxide concentration at the second time point, and the supply amount of carbon dioxide. The growth state estimation method may comprise estimating a growth state of the plant based on relationship information indicating relationship between the consumption amount of carbon dioxide and the growth state of the plant being cultivated in the plant factory, and the consumption amount identified.

A growth state estimation method according to an aspect of the present invention may comprise acquiring a supply amount of nutrient solution containing a fertilizer component that is supplied, via nutrient solution supply equipment having a tank for storing the nutrient solution, to a plant cultivated in a plant factory from a first time point to a second time point after the first time point. The growth state estimation method may comprise estimating a growth state of the plant based on relationship information indicating relationship between the supply amount of the nutrient solution and the growth state of the plant, and the supply amount of the nutrient solution.

A plant management method according to an aspect of the present invention may comprise estimating the growth state of the plant in accordance with the growth state estimation method according to any of the growth state estimation methods. The plant management method may comprise controlling environmental control equipment which controls environment in the plant factory such that the growth state of the plant estimated becomes a predetermined growth state to be satisfied at the second time point.

A program according to an aspect of the present invention may cause a computer to perform acquiring a carbon dioxide concentration at a first time point in a plant factory and a carbon dioxide concentration at a second time point after the first time point, detected by a sensor provided in the plant factory. The program may cause the computer to perform acquiring a supply amount of carbon dioxide supplied from the first time point to the second time point in the plant factory via carbon dioxide supply equipment having a tank for storing carbon dioxide. The program may cause the computer to perform identifying a consumption amount of carbon dioxide consumed by a plant being cultivated in the plant factory from the first time point to the second time point, based on the carbon dioxide concentration at the first time point, the carbon dioxide concentration at the second time point, and the supply amount of carbon dioxide. The program may cause the computer to perform estimating a growth state of the plant based on relationship information indicating relationship between the consumption amount of carbon dioxide and the growth state of the plant in the plant factory, and the consumption amount identified.

A program according to an aspect of the present invention may cause a computer to perform acquiring a supply amount of nutrient solution containing a fertilizer component that is supplied, via nutrient solution supply equipment having a tank for storing the nutrient solution, to a plant cultivated in a plant factory from a first time point to a second time point after the first time point. The program may cause the computer to perform estimating a growth state of the plant based on relationship information indicating relationship between the supply amount of the nutrient solution and the growth state of the plant, and the supply amount of the nutrient solution.

The summary clause does not necessarily describe all necessary features of the embodiments of the present invention. The present invention may also be a sub-combination of the features described above.

### BRIEF DESCRIPTION OF THE DRAWINGS

FIG. 1 illustrates an example of a functional block of an overall configuration of a plant management system according to the present embodiment.

FIG. 2 illustrates an example of a functional block of a plant management apparatus.

FIG. 3A illustrates an example of relationship information indicating relationship between a growth state of a plant and a consumption amount of carbon dioxide.

FIG. 3B illustrates an example of relationship information indicating relationship between a growth state of a plant and a supply amount of nutrient solution.

FIG. 4 is a flowchart illustrating an example procedure of estimation of the growth state of the plant 30 and environmental control, based on the consumption amount of carbon dioxide.

FIG. 5 is a flowchart illustrating an example procedure of estimation of the growth state of the plant 30 and environmental control, based on the consumption amount of carbon dioxide and the supply amount of nutrient solution.

FIG. 6 illustrates an example of a hardware configuration.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

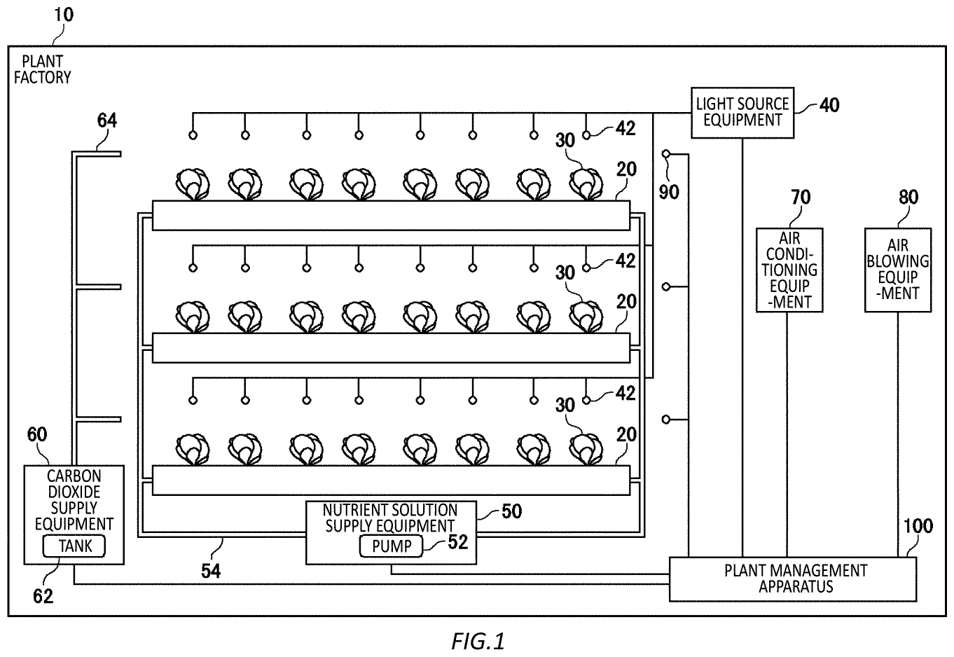

FIG. 1 illustrates an example of a functional block of an overall configuration of a plant management system according to the present embodiment. The plant management system manages a growth state of a plant 30 that is cultivated in a plant factory 10. The plant management system includes a plurality of cultivation racks 20, light source equipment 40, nutrient solution supply equipment 50, carbon dioxide supply equipment 60, air conditioning equipment 70, air blowing equipment 80, a sensor 90, and a plant management apparatus 100. The light source equipment 40, the nutrient solution supply equipment 50, the carbon dioxide supply equipment 60, the air conditioning equipment 70, and the air blowing equipment 80 are examples of the environmental control equipment.

The cultivation rack 20 cultivates the plant 30 such as a vegetable, a fruit, or a fresh flower. The light source equipment 40 includes a plurality of light sources 42 such as LEDs or incandescent lamps that radiate artificial light, and radiates the artificial light to the plant 30 from each of the plurality of light sources 42. The plurality of light sources 42 may be arranged to face a cultivation surface of the cultivation rack 20.

The nutrient solution supply equipment 50 has a pump 52 and a pipe 54, and supplies, to the cultivation rack 20 via the pump 52 and the pipe 54, a nutrient solution containing one or more fertilizer components such as potassium or calcium. The nutrient solution supply equipment 50 appropriately adjusts a fertilizer concentration, and supplies, to the plant 30, the nutrient solution with the adjusted fertilizer concentration. The nutrient solution supply equipment 50 may supply the nutrient solution to the plant 30 by atomizing the nutrient solution with the adjusted fertilizer concentration and spraying the atomized nutrient solution onto a root part of the plant 30. The nutrient solution supply equipment 50 may function as irrigation equipment that supplies water to a medium in which the plant 30 is cultivated. An amount of irrigation that is supplied to the cultivation rack 20 may be adjusted by adjusting an amount of the nutrient solution that is supplied to the cultivation rack 20 from the nutrient solution supply equipment 50.

The carbon dioxide supply equipment 60 has a tank 62 and a nozzle 64. The tank 62 stores carbon dioxide. The carbon dioxide supply equipment 60 supplies carbon dioxide stored in the tank 62, to the inside of the plant factory 10 via the nozzle 64.

The air conditioning equipment 70 controls a temperature and humidity of an air in the plant factory 10, and circulates the air of which the temperature and the humidity are controlled, into each space. The air blowing equipment 80 includes a circulator or a fan that supplies a wind into the plant factory 10.

The sensor 90 is a CO₂ sensor which detects a carbon dioxide concentration in the plant factory 10. A plurality of the sensor 90 may be provided in the plant factory 10. The sensor 90 may be provided for each cultivation rack 20. The sensor 90 periodically detects the carbon dioxide concentration in the plant factory 10, and provides the plant management apparatus 100 with the detection result. Only one sensor 90 may be provided in the plant factory 10.

The plant management apparatus 100 controls the growth state of the plant 30 by controlling the light source equipment 40, the nutrient solution supply equipment 50, the carbon dioxide supply equipment 60, the air conditioning equipment 70, and the air blowing equipment 80. The plant management apparatus 100 communicates with the light source equipment 40, the nutrient solution supply equipment 50, the carbon dioxide supply equipment 60, the air conditioning equipment 70, the air blowing equipment 80, and the sensor 90, via a wireless network or a wired network. The plant management apparatus 100 is an example of the growth state estimation apparatus.

The plant management apparatus 100 may be a computer having a central processing unit (CPU) and a memory. Each of the light source equipment 40, the nutrient solution supply equipment 50, the carbon dioxide supply equipment 60, the air conditioning equipment 70, and the air blowing equipment 80 may include a computer having a central processing unit (CPU) and a memory.

The computer may be a computer such as a personal computer, a tablet type computer, a smartphone, a workstation, a server computer, or a general purpose computer, or may be a computer system in which a plurality of computers are connected. Such a computer system is also a computer in a broad sense. The computer may be a dedicated computer designed for an environmental control of a plant factory, or may be dedicated hardware realized by dedicated circuitry. The computer may be implemented by a virtual computer environment. When the computer is used, the plant management apparatus 100, the light source equipment 40, the nutrient solution supply equipment 50, the carbon dioxide supply equipment 60, the air conditioning equipment 70, and the air blowing equipment 80 are realized by executing a program by the computer.

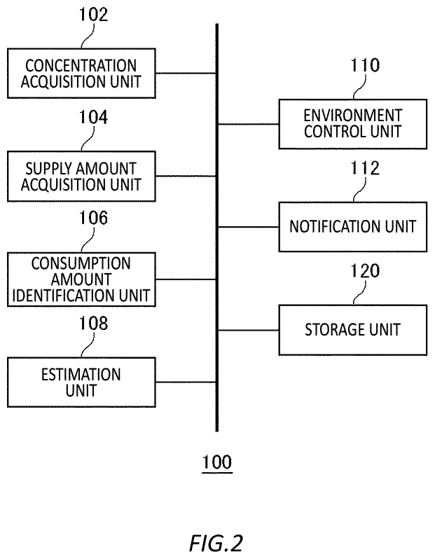

FIG. 2 illustrates an example of a functional block of a plant management apparatus 100. The plant management apparatus 100 comprises a concentration acquisition unit 102, a supply amount acquisition unit 104, a consumption amount identification unit 106, an estimation unit 108, an environment control unit 110, a notification unit 112, and a storage unit 120.

The concentration acquisition unit 102 periodically acquires the carbon dioxide concentration from each of the plurality of sensors 90. The concentration acquisition unit 102 may acquire an average value of the carbon dioxide concentration acquired from each of the plurality of sensors 90, as the carbon dioxide concentration in the plant factory 10. The concentration acquisition unit 102 may acquire, from the plurality of sensors 90, the carbon dioxide concentration at time point T1 and the carbon dioxide concentration at time point T2 in the plant factory 10, which is later than time point T1. The concentration acquisition unit 102 may acquire the carbon dioxide concentration from each of the plurality of sensors 90 every hour, every six hours, every twelve hours, or every twenty-four hours, and register the average value of the carbon dioxide concentrations from the plurality of sensors 90 to the storage unit 120 as the carbon dioxide concentration in the plant factory 10.

The supply amount acquisition unit 104 acquires the supply amount of carbon dioxide supplied, via carbon dioxide supply equipment 60 having a tank 62 for storing carbon dioxide, in the plant factory 10 during a predetermined period. The supply amount acquisition unit 104 acquires the supply amount of carbon dioxide supplied in the plant factory 10 from time point T1 to time point T2. The supply amount acquisition unit 104 may acquire the supply amount of carbon dioxide supplied in the plant factory 10 during the predetermined period, for each predetermined period. The supply amount acquisition unit 104 may acquire the supply amount of carbon dioxide supplied in the plant factory 10 every hour, every six hours, every twelve hours, or every twenty-four hours.

The consumption amount identification unit 106 identifies the consumption amount of carbon dioxide consumed by the plant 30 in the plant factory 10, based on the carbon dioxide concentration in the plant factory 10 detected by the plurality of sensors 90 and the supply amount of carbon dioxide supplied in the plant factory 10 via the carbon dioxide supply equipment 60. The consumption amount identification unit 106 identifies the consumption amount of carbon dioxide consumed by the plant 30 in the plant factory 10 from time point T1 to time point T2, based on the carbon dioxide concentration at time point T1, the carbon dioxide concentration at time point T2, and the supply amount of carbon dioxide from time point T1 to time point T2. The consumption amount identification unit 106 identifies the consumption amount of carbon dioxide of the entire plants 30 being cultivated in the plant factory 10. The consumption amount identification unit 106 identifies the consumption amount of carbon dioxide by the entire plants 30, among the plants 30 being cultivated in the plant factory 10, being cultivated in an area in which the carbon dioxide concentration is detected by the sensors 90, and for which the supply amount of carbon dioxide being supplied from the carbon dioxide supply equipment 60 said area is known.

The consumption amount identification unit 106 derives the amount of carbon dioxide in the plant factory 10 at time point T1 by multiplying the carbon dioxide concentration (ppm) at time point T1 by the capacity (m³) of the plant factory 10. Similarly, the consumption amount identification unit 106 derives the amount of carbon dioxide in the plant factory 10 at time point T2. The consumption amount identification unit 106 then identifies the consumption amount of carbon dioxide consumed by the plant 30 in the plant factory 10 from time point T1 to time point T2 by subtracting the amount of carbon dioxide in the plant factory 10 at time point T2 from the sum total of the amount of carbon dioxide in the plant factory 10 at time point T1 and the supply amount of carbon dioxide from time point T1 to time point T2.

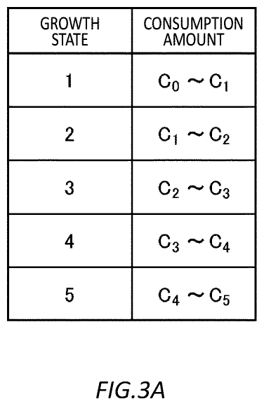

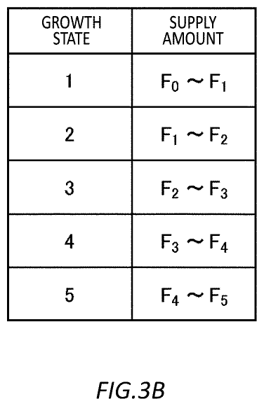

The estimation unit 108 estimates the growth state of the plant based on the relationship information indicating relationship between the consumption amount of carbon dioxide and the growth state of the plant being cultivated in the plant factory 10, and the consumption amount of carbon dioxide identified by the consumption amount identification unit 106. For example, the growth state may be distinguished by a dividing the growth state may from planting to harvesting of the plant into a plurality of steps. For example, the relationship information associates each of the steps obtained by dividing the growth state from planting to harvesting into five steps, as illustrated in FIG. 3A, with a range of consumption amount of carbon dioxide. As the plant 30 grows, the consumption amount of carbon dioxide consumed by the plant 30 increases.

Accordingly, the relationship information may be step-wise information indicating that the larger the consumption amount of carbon dioxide, the more the growth state of the plant 30 has progressed. The relationship information may be generated by actually measuring, for each type of the plant 30, the consumption amount of carbon dioxide for each step of the growth state of the plant 30 by means of an experiment or the like, and collecting statistical data. The relationship information may be registered in advance in the storage unit 120.

There may be factors other than the plant 30 for the carbon dioxide being consumed in the plant factory 10. Therefore a predetermined basic consumption amount, which is a consumption amount of carbon dioxide consumed in the plant factory 10 during a period corresponding to a period from time point T1 to time point T2 without the plant 30 being cultivated in the plant factory 10, may be derived by means of an experiment or the like, and the basic consumption amount may be registered in advance to the storage unit 120.

The consumption amount identification unit 106 may identify the consumption amount of carbon dioxide consumed by the plant 30 in the plant factory 10 from time point T1 to time point T2 further based on the basic consumption amount. That is, the consumption amount identification unit 106 may identify the consumption amount of carbon dioxide consumed by the plant 30 in the plant factory 10 from time point T1 to time point T2 by subtracting the amount of carbon dioxide in the plant factory 10 at time point T2 from the sum total of the amount of carbon dioxide in the plant factory 10 at time point T1 and the supply amount of carbon dioxide from time point T1 and time point T2, and further subtracting the basic consumption amount therefrom.

There is a possibility that people visits the plant factory 10. In a case where people visits the plant factory 10, it is better for the consumption amount identification unit 106 to identify the consumption amount of carbon dioxide consumed by the plant 30 by taking into consideration the amount of carbon dioxide emitted by people. Therefore, the consumption amount identification unit 106 may identify the discharge amount of carbon dioxide discharged by people from time point T1 to time point T2 based on the number and stay time of people existing in the plant factory 10 between time point T1 and time point T2, and identify the consumption amount of carbon dioxide consumed by the plant 30 in the plant factory 10 from time point T1 to time point T2 further based on the discharge amount of carbon dioxide identified.

The storage unit 120 may store the amount of carbon dioxide emitted by one person per unit time. A motion detector may be provided at the entrance of the plant factory 10, and the plant management apparatus 100 may measure the number and stay time of people existing in the plant factory 10 and the store the result thereof in the storage unit 120. The consumption amount identification unit 106 derives the total amount of carbon dioxide generated by people in the plant factory 10 between time point T1 and time point T2, based on the number of people existing in the plant factory 10 between time point T1 and the time point T2 and the stay time of each person. The consumption amount identification unit 106 may then sum up the supply amount of carbon dioxide supplied in the plant factory 10 between time point T1 and time point T2 and the total amount of carbon dioxide generated by people, and identify the consumption amount of carbon dioxide consumed by the plant 30 in the plant factory 10 from time point T1 to time point T2 by subtracting, from the sum total of the above sum amount and the amount of carbon dioxide in the plant factory 10 at time point T1, the amount of carbon dioxide in the plant factory 10 at time point T2.

The environment control unit 110 controls at least one environmental control equipment of the light source equipment 40, the nutrient solution supply equipment 50, the carbon dioxide supply equipment 60, the air conditioning equipment 70, or the air blowing equipment 80, each controlling the environment in the plant factory 10, such that the growth state of the plant 30 estimated by the estimation unit 108 becomes the predetermined growth state to be satisfied at time point T2.

The environment control unit 110 may adjust a fertilizer concentration of the nutrient solution supplied to the medium in the cultivation rack 20 by the nutrient solution supply equipment 50, such that the growth state of the plant 30 estimated by the estimation unit 108 becomes a predetermined growth state to be satisfied at the time point T2. The environment control unit 110 may adjust the fertilizer concentration of the nutrient solution supplied to the medium in the cultivation rack 20 by the nutrient solution supply equipment 50 to be increased, when the growth state of the plant 30 estimated by the estimation unit 108 has not reached the predetermined growth state to be satisfied at the time point T2. The environment control unit 110 may adjust the fertilizer concentration of the nutrient solution supplied to the medium in the cultivation rack 20 by the nutrient solution supply equipment 50 to be reduced, when the growth state of the plant 30 estimated by the estimation unit 108 has exceeded the predetermined growth state to be satisfied at the time point T2. If the plant 30 is tomato or the like, whose growth state varies according to the amount of irrigation, the environment control unit 110 may adjust the amount of irrigation to be supplied to the culture in the cultivation rack 20 by the nutrient solution supply equipment 50, such that the growth state of the plant 30 estimated by the estimation unit 108 becomes the predetermined growth state to be satisfied at time point T2.

The environment control unit 110 may adjust an amount and irradiation time of the light radiated to the plant 30 by the light source equipment 40, such that the growth state of the plant 30 estimated by the estimation unit 108 becomes a predetermined growth state to be satisfied at the time point T2. The environment control unit 110 may increase an amount of light radiated to the plant 30 by the light source equipment 40, when the growth state of the plant 30 estimated by the estimation unit 108 has not reached the predetermined growth state to be satisfied at the time point T2. Alternatively, the environment control unit 110 may extend the irradiation time of the light to the plant 30 by the light source equipment 40. On the other hand, the environment control unit 110 may reduce the amount of light radiated to the plant 30 by the light source equipment 40, when the growth state of the plant 30 estimated by the estimation unit 108 has exceeded the predetermined growth state to be satisfied at time point T2. Alternatively, the environment control unit 110 may reduce the irradiation time of light to the plant 30 by the light source equipment 40.

When the consumption amount of carbon dioxide identified by the consumption amount identification unit 106 is too small, there is a possibility that an abnormality has occurred in at least one environmental control equipment of the light source equipment 40, the nutrient solution supply equipment 50, the carbon dioxide supply equipment 60, the air conditioning equipment 70, or the air blowing equipment 80, each controlling the environment in the plant factory 10.

Therefore, the notification unit 112 sends a message indicating an abnormality occurrence in the environmental control equipment, when the consumption amount of carbon dioxide identified by the consumption amount identification unit 106 is less than a predetermined threshold. The notification unit 112 may send a message to an administrator who manages the plant factory 10. The notification unit 112 may cause a message to be displayed on a display included in the plant management apparatus 100. The notification unit 112 may send a message to a terminal possessed by an administrator who manages the plant factory 10.

In the above, description has been made taking a case where the estimation unit 108 estimates the growth state of a plant based on relationship information indicating the relationship between the consumption amount of carbon dioxide and the growth state of the plant being cultivated in the plant factory 10, and the consumption amount of carbon dioxide identified by the consumption amount identification unit 106, as an example. However, the estimation unit 108 may estimate the growth state of the plant 30 based on the supply amount of nutrient solution supplied by the nutrient solution supply equipment 50, instead of the consumption amount of carbon dioxide or in addition to the consumption amount of carbon dioxide. Note that, the nutrient solution supply equipment 50 may additionally supply nutrient solution to the plant 30 according to the consumption amount of the nutrient solution consumed by the plant 30. That is, the supply amount of the nutrient solution supplied by the nutrient solution supply equipment 50 corresponds to the consumption amount of the nutrient solution consumed by the plant 30.

The supply amount acquisition unit 104 may acquire the supply amount of the nutrient solution supplied to the culture in the cultivation rack 20 by the nutrient solution supply equipment 50 between time point T1 and time point T2. The estimation unit 108 may estimate the growth state of the plant 30 based on relationship information indicating the relationship between the supply amount of the nutrient solution and the growth state of the plant being cultivated in the plant factory 10, and the supply amount of the nutrient solution acquired by the supply amount acquisition unit 104. For example, the relationship information associates each of the steps obtained by dividing the growth state from planting to harvesting into five steps, as illustrated in FIG. 3B, with a range of supply amount of the nutrient solution. As the plant 30 grows, the consumption amount of the nutrient solution consumed by the plant 30 increases, so the supply amount thereof is also increased. Accordingly, the relationship information may be step-wise information indicating that the larger the supply amount of the nutrient solution, the more the growth state of the plant 30 has progressed. The relationship information may be generated by actually measuring, for each type of the plant 30, the supply amount of the nutrient solution for each step of the growth state of the plant 30 by means of an experiment or the like, and collecting statistical data. The relationship information may be registered in advance in the storage unit 120.

The estimation unit 108 may finally estimate the growth state of the plant 30 based on the growth state of the plant 30 estimated based on the consumption amount of the carbon dioxide, and the growth state of the plant 30 estimated based on the supply amount of the nutrient solution. By using two parameters to estimate the growth state of the plant 30, the growth state of the plant 30 can be estimated more precisely.

When the growth state of the plant 30 estimated based on the consumption amount of the carbon dioxide and the growth state of the plant 30 estimated based on the supply amount of the nutrient solution match, the estimation unit 108 may use the growth state that has matched as a growth state of the plant 30 for controlling environmental control equipment which controls environment in the plant factory 10. On the other hand, when the growth state of the plant 30 estimated based on the consumption amount of the carbon dioxide and the growth state of the plant 30 estimated based on the supply amount of the nutrient solution does not match, the estimation unit 108 may not use the growth state that has matched as a growth state of the plant 30 for controlling environmental control equipment which controls environment in the plant factory 10.

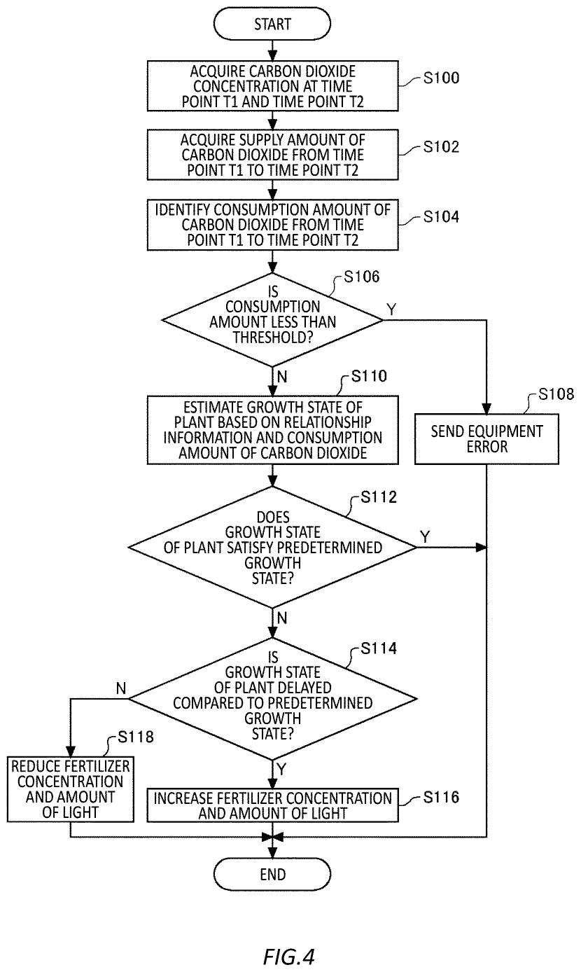

FIG. 4 is a flowchart illustrating an example procedure of estimation of the growth state of the plant 30 and environmental control, based on the consumption amount of carbon dioxide.

The concentration acquisition unit 102 acquires the carbon dioxide concentrations at time point T1 and time point T2 detected by the sensor 90 (S100). The supply amount acquisition unit 104 acquires the supply amount of carbon dioxide supplied in the plant factory 10 from the carbon dioxide supply equipment 60 from time point T1 to time point T2 (S102). The consumption amount identification unit 106 identifies the consumption amount of carbon dioxide consumed by the plant 30 between time point T1 and time point T2, based on the carbon dioxide concentrations at time point T1 and time point T2, the supply amount of carbon dioxide from time point T1 to time point T2, the basic consumption amount, and the supply amount of carbon dioxide by people visiting the plant factory 10 (S104).

When the consumption amount of carbon dioxide is less than the threshold (“Y” at S106), the notification unit 112 sends an equipment error indicating an abnormality in the environmental control equipment to the outside (S108). On the other hand, when the consumption amount of carbon dioxide is equal to or more than the threshold (“N” at S106), the estimation unit 108 estimates the growth state of the plant 30 in the plant factory 10 based on the relationship information and the consumption amount of carbon dioxide identified (S110).

The environment control unit 110 determines whether the growth state of the plant 30 estimated is the predetermined growth state expected at time point T2 (S112). If the growth state of the plant 30 estimated is the predetermined growth state expected at time point T2, the processing is terminated.

When the growth state of the plant 30 estimated is not the predetermined growth state expected at time point T2, the environment control unit 110 controls the nutrient solution supply equipment 50 and the light source equipment 40 in order to increase the fertilizer concentration of the nutrient solution supplied to the medium in the cultivation rack 20 and the amount of light radiated to the plant 30 (S116), when the growth state of the plant 30 estimated is delayed compared to the predetermined growth state expected at time point T2 (“Y” at S114). If the growth state of the plant 30 varies according to the amount of irrigation, the environment control unit 110 may increase the amount of irrigation supplied to the plant 30, instead of adjusting the fertilizer concentration.

On the other hand, the environment control unit 110 controls the nutrient solution supply equipment 50 and the light source equipment 40 in order to reduce the fertilizer concentration of the nutrient solution supplied to the medium in the cultivation rack 20 and the amount of light radiated to the plant 30 (S118), when the growth state of the plant 30 estimated is advanced compared to the predetermined growth state expected at time point T2 (“N” at S114).

If the growth state of the plant 30 varies according to the amount of irrigation, the environment control unit 110 may reduce the amount of irrigation supplied to the plant 30, instead of adjusting the fertilizer concentration.

As described above, in accordance with the plant management apparatus 100 according to the present embodiment, the consumption amount of carbon dioxide being consumed in the entire plant 30 being cultivated in the plant factory 10 is identified, and based on that consumption amount, the growth state of the entire plant 30 being cultivated in the plant factory 10 is estimated. Further, the plant management apparatus 100 controls the environmental control equipment which controls the environment in the plant factory 10 such that the plant 30 is at a growth state to be satisfied, based on the estimation result of the growth state. By using existing equipment installed in the plant factory 10 and estimating the consumption amount of carbon dioxide, the growth state of the plant 30 can be known, and the environment in the plant factory 10 can be controlled appropriately.

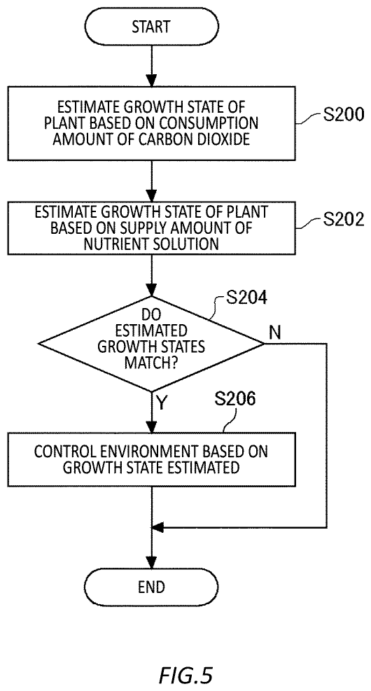

FIG. 5 is a flowchart illustrating an example procedure of estimation of the growth state of the plant 30 and environmental control, based on the consumption amount of carbon dioxide and the supply amount of nutrient solution.

The estimation unit 108 estimates the growth state of the plant 30 based on the relationship information indicating relationship between the consumption amount of carbon dioxide and the growth state of the plant being cultivated in the plant factory 10, and the consumption amount of carbon dioxide identified by the consumption amount identification unit 106 (S200). The estimation unit 108 estimates the growth state of the plant 30 based on relationship information indicating the relationship between the supply amount of the nutrient solution and the growth state of the plant 30 being cultivated in the plant factory 10, and the supply amount of the nutrient solution acquired by the supply amount acquisition unit 104 (S202).

The estimation unit 108 determines whether the growth state of the plant 30 estimated based on the consumption amount of carbon dioxide and the growth state of the plant 30 estimated based on the supply amount of the nutrient solution match (S204). When the estimated growth states match, the environment control unit 110 controls the environmental control equipment such as the light source equipment 40 and the nutrient solution supply equipment 50, based on the growth state of the plant 30 estimated (S206). On the other hand, when the estimated growth states do not match, the environment control unit 110 does not control the environmental control equipment such as the light source equipment 40 and the nutrient solution supply equipment 50 based on the growth state of the plant 30 estimated, and the processing is terminated.

As described above, in accordance with the plant management apparatus 100 according to embodiments, the consumption amount of carbon dioxide being consumed by the entire plant 30 being cultivated in the plant factory 10 and the supply amount of the nutrient solution supplied to the plant 30 are identified, and based on those consumption amount and supply amount, the growth state of the entire plant 30 being cultivated in the plant factory 10 is estimated. The plant management apparatus 100 can estimate the growth state of the plant 30 more precisely by estimating the final growth state of the plant 30 taking into consideration the growth state estimated based on each of the consumption amount of carbon dioxide and the supply amount of the nutrient solution. Therefore, the plant management apparatus 100 can control the environmental control equipment more precisely such that the environment in the plant factory 10 becomes the growth state to be satisfied by the plant 30, based on the estimation result of the growth state.

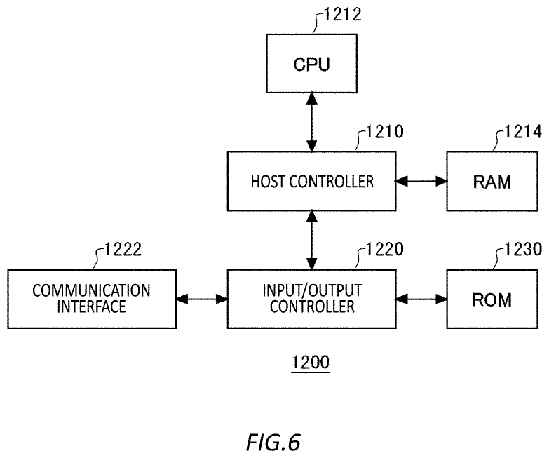

FIG. 6 illustrates an example of a computer 1200 which may entirely or partially embody an aspect of the present embodiment. Programs installed in the computer 1200 can cause the computer 1200 to function as operations associated with the apparatus according to the embodiments of the present invention or one or more “units” of the apparatuses. Alternatively, the programs can cause the computer 1200 to execute the operations or the one or more “units”. The programs can cause the computer 1200 to execute a process according to the embodiments of the present invention or steps of the process. Such programs may be executed by a CPU 1212 to cause the computer 1200 to perform specific operations associated with some or all of the blocks in the flowcharts and block diagrams described in the present specification.

The computer 1200 according to the present embodiment includes the CPU 1212 and a RAM 1214, which are mutually connected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or stores programs depending on hardware of the computer 1200. The programs are provided via a computer readable storage medium such as CR-ROM, a USB memory or an IC Card or a network. The programs are installed on the RAM 1214, which also is an example of the computer readable storage medium, or the ROM 1230 and performed by the CPU 1212. Information processing written in these programs is read by the computer 1200, and provides cooperation between the programs and the various types of hardware resources described above. An apparatus or a method may be configured by implementing operations or processing of information according to a use of the computer 1200.

For example, in a case where a communication is performed between the computer 1200 and an external device, the CPU 1212 may execute a communication program loaded in the RAM 1214 and instruct the communication interface 1222 to perform communication processing based on a process written in the communication program. Under the control of the CPU 1212, the communication interface 1222 reads transmission data which is stored in the RAM 1214 or a transmission buffer region which is provided in a storage media such as a USB memory, to transmit the read transmission data to the network or write the reception data received from the network into a reception buffer region or the like provided on the storage media.

Also, the CPU 1212 may cause the whole or required part of files which are stored in the external storage media (such as USB memory) or the database to be read by the RAM 1214, to perform a various type of processes for the data on the RAM 1214. Then, the CPU 1212 may write back the processed data to the external storage media.

Various types of information such as various types of programs, data, tables and databases may be stored in a storage media to undergo an information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. Also, the CPU 1212 may retrieve information in the file, database or the like in the storage media. For example, when a plurality of entries each having an attribute value of the first attribute associated with an attribute value of the second attribute are stored in a storage media, the CPU 1212 may retrieve, among the plurality of entries, an entry whose attribute value of the first attribute is specified and matches the conditions and read the attribute value of the second attribute stored in the entry, thereby acquiring the attribute value of the second attribute associated with the first attribute which satisfies a predetermined condition.

The programs or software module described above may be stored on the computer 1200 or in a computer readable storage medium near the computer 1200. In addition, a recording medium such as a hard disk or a RAM provided in a server system connected to a dedicated communication network or the Internet can be used as the computer readable storage medium, so that the programs are provided to the computer 1200 via the network.

A computer readable medium may include any tangible device that can store instructions to be executed by a suitable device. As a result, the computer readable medium having instructions stored therein includes an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. More specific examples of computer readable media may include a floppy (registered trademark) disk, a diskette, a hard disk, a random access memory (RAM), a read only memory (ROM), an erasable programmable read only memory (EPROM or Flash memory), an electrically erasable programmable read only memory (EEPROM), a static random access memory (SRAM), a compact disc read only memory (CD-ROM), a digital versatile disk (DVD), a BLU-RAY (registered trademark) disc, a memory stick, an integrated circuit card, etc.

Computer readable instructions may include either a source code or an object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and programming languages, such as the “C” programming language or similar programming languages. Computer readable instructions may be provided to a processor of a general purpose computer, special purpose computer, or other programmable data processing device, or to programmable circuitry, locally or via a local area network (LAN), a wide area network (WAN) such as the Internet, etc. The processor or the programmable circuitry may execute the computer readable instructions in order to create means for performing operations specified in the flowcharts or block diagrams. An example of the processor includes a computer processor, processing unit, microprocessor, digital signal processor, controller, microcontroller, or the like.

While the present invention has been described by way of the embodiments, the technical scope of the present invention is not limited to the above described embodiments. It is apparent to persons skilled in the art that various alterations or improvements can be made to the above-described embodiments. It is apparent from the description of the claims that embodiments added with such alterations or improvements can also be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: plant factory,
20: cultivation rack,
30: plant,
40: light source equipment,
42: light source,
50: nutrient solution supply equipment,
52: pump,
54: pipe,
60: carbon dioxide supply equipment,
62: tank,
64: nozzle,
70: air conditioning equipment,
80: air blowing equipment,
90: sensor,
100: plant management apparatus,
102: concentration acquisition unit,
104: supply amount acquisition unit,
106: consumption amount identification unit,
108: estimation unit,
110: environment control unit,
112: notification unit,
120: storage unit,
1200: computer,
1210: host controller,
1212: CPU,
1214: RAM
1220: input/output controller,
1222: communication interface,
1230: ROM.

1. A growth state estimation apparatus comprising a processor, wherein the processor:
acquires a carbon dioxide concentration at a first time point in a plant factory and a carbon dioxide concentration at a second time point after the first time point, detected by a sensor provided in the plant factory;
acquires a supply amount of carbon dioxide supplied from the first time point to the second time point in the plant factory via carbon dioxide supply equipment having a tank for storing carbon dioxide;
identifies a consumption amount of carbon dioxide consumed by a plant being cultivated in the plant factory from the first time point to the second time point, based on the carbon dioxide concentration at the first time point, the carbon dioxide concentration at the second time point, and the supply amount of carbon dioxide; and
estimates a growth state of the plant based on relationship information indicating relationship between the consumption amount of carbon dioxide and the growth state of the plant in the plant factory, and the consumption amount identified.

2. The growth state estimation apparatus according to claim 1, wherein the processor identifies a consumption amount of carbon dioxide consumed by the plant in the plant factory from the first time point to the second time point, further based on a predetermined basic consumption amount which is a consumption amount of carbon dioxide consumed in the plant factory during a period corresponding to a period from the first time point to the second time point without the plant being cultivated in the plant factory.

3. The growth state estimation apparatus according to claim 1, wherein the processor identifies a discharge amount of carbon dioxide discharged by people from the first time point to the second time point, based on a number and staying time of people existing in the plant factory between the first time point to the second time point, and identifies a consumption amount of carbon dioxide consumed by the plant in the plant factory from the first time point to the second time point, further based on the discharge amount of carbon dioxide by people identified.

4. The growth state estimation apparatus according to claim 1, wherein
the processor acquires a supply amount of nutrient solution containing a fertilizer component that is supplied, via nutrient solution supply equipment having a tank for storing the nutrient solution, to the plant from the first time point to the second time point,
the processor estimates the growth state of the plant based on relationship information indicating relationship between the supply amount of the nutrient solution and the growth state of the plant, and the supply amount of the nutrient solution, and
the processor estimates the growth state of the plant based on the growth state of the plant estimated based on the consumption amount of the carbon dioxide, and the growth state of the plant estimated based on the supply amount of the nutrient solution.

5. The growth state estimation apparatus according to claim 4, wherein when the growth state of the plant estimated based on the consumption amount of the carbon dioxide and the growth state of the plant estimated based on the supply amount of the nutrient solution match, the processor uses the growth state that has matched as a growth state of the plant for controlling environmental control equipment which controls environment in the plant factory.

6. The growth state estimation apparatus according to claim 4, wherein when the growth state of the plant estimated based on the consumption amount of the carbon dioxide and the growth state of the plant estimated based on the supply amount of the nutrient solution do not match, the processor does not use the growth state that did not match as a growth state of the plant for controlling environmental control equipment which controls environment in the plant factory.

7. A growth state estimation apparatus comprising a processor, wherein the processor:
acquires a supply amount of nutrient solution containing a fertilizer component that is supplied, via nutrient solution supply equipment having a tank for storing the nutrient solution, to a plant cultivated in a plant factory from a first time point to a second time point after the first time point; and
estimates a growth state of the plant based on relationship information indicating relationship between the supply amount of the nutrient solution and the growth state of the plant, and the supply amount of the nutrient solution.

8. The plant management system comprising:
a growth state estimation apparatus according to any one of claims 1; and
the processor controls environmental control equipment which controls environment in the plant factory such that the growth state of the plant estimated by the processor becomes a predetermined growth state to be satisfied at the second time point.

9. The plant management system according to claim 8, wherein
the environmental control equipment includes nutrient solution supply equipment which supplies nutrient solution containing a fertilizer component to the plant, and
the processor adjusts a fertilizer concentration of the nutrient solution supplied to the plant by the nutrient solution supply equipment, such that the growth state of the plant estimated by the processor becomes a predetermined growth state to be satisfied at the second time point.

10. The plant management system according to claim 8, wherein
the environmental control equipment includes irrigation equipment which supplies water to a medium in which the plant is being cultivated; and
the processor adjusts an amount of irrigation to the medium by the irrigation equipment, such that the growth state of the plant estimated by the processor becomes a predetermined growth state to be satisfied at the second time point.

11. The plant management system according to claim 8, wherein
the environmental control equipment includes light source equipment having a light source which radiates artificial light onto the plant; and
the processor adjusts an amount and irradiation time of the light radiated to the plant by the light source equipment, such that the growth state of the plant estimated by the processor becomes a predetermined growth state to be satisfied at the second time point.

12. The plant management system comprising:
the growth state estimation apparatus according to any one of claim 1, and wherein the processor:
controls environmental control equipment which controls environment in a plant factory, such that the growth state of the plant estimated by the processor becomes a predetermined growth state to be satisfied at the second time point, and
sends a message indicating abnormality occurrence in the environmental control equipment when the consumption amount of carbon dioxide identified by the processor is less than a predetermined threshold.

13. A growth state estimation method comprising:
acquiring a carbon dioxide concentration at a first time point in a plant factory and a carbon dioxide concentration at a second time point after the first time point, detected by a sensor provided in the plant factory;
acquiring a supply amount of carbon dioxide supplied from the first time point to the second time point in the plant factory via carbon dioxide supply equipment having a tank for storing carbon dioxide;
identifying a consumption amount of carbon dioxide consumed by a plant being cultivated in the plant factory from the first time point to the second time point, based on the carbon dioxide concentration at the first time point, the carbon dioxide concentration at the second time point, and the supply amount of carbon dioxide; and
estimating a growth state of the plant based on relationship information indicating relationship between the consumption amount of carbon dioxide and the growth state of the plant in the plant factory, and the consumption amount identified.

14. The growth state estimation method according to claim 13, further comprising:
acquiring a supply amount of nutrient solution containing a fertilizer component that is supplied, via nutrient solution supply equipment having a tank for storing the nutrient solution, to a plant cultivated in a plant factory from the first time point to the second time point; and
estimating a growth state of the plant based on relationship information indicating relationship between the supply amount of the nutrient solution and the growth state of the plant, and the supply amount of the nutrient solution.

15. A plant management method comprising:
estimating the growth state of the plant in accordance with the growth state estimation method according to claim 13; and
controlling environmental control equipment which controls environment in the plant factory such that the growth state of the plant estimated becomes a predetermined growth state to be satisfied at the second time point.

16. A non-transitory computer readable medium having recorded thereon a program for, when executed by a computer, causing the computer to perform:
acquiring a carbon dioxide concentration at a first time point in a plant factory and a carbon dioxide concentration at a second time point after the first time point, detected by a sensor provided in the plant factory;
acquiring a supply amount of carbon dioxide supplied from the first time point to the second time point in the plant factory via carbon dioxide supply equipment having a tank for storing carbon dioxide;
identifying a consumption amount of carbon dioxide consumed by a plant being cultivated in the plant factory from the first time point to the second time point, based on the carbon dioxide concentration at the first time point, the carbon dioxide concentration at the second time point, and the supply amount of carbon dioxide; and
estimating a growth state of the plant based on relationship information indicating relationship between the consumption amount of carbon dioxide and the growth state of the plant in the plant factory, and the consumption amount identified.

17. The non-transitory computer readable medium according to claim 16, having recorded thereon a program for, when executed by a computer, further causing the computer to perform:
acquiring a supply amount of nutrient solution containing a fertilizer component that is supplied, via nutrient solution supply equipment having a tank for storing the nutrient solution, to a plant cultivated in a plant factory from the first time point to the second time point; and
estimating a growth state of the plant based on relationship information indicating relationship between the supply amount of the nutrient solution and the growth state of the plant, and the supply amount of the nutrient solution.

18. A plant management method comprising:
estimating the growth state of the plant in accordance with the growth state estimation method according to claim 14; and
controlling environmental control equipment which controls environment in the plant factory such that the growth state of the plant estimated becomes a predetermined growth state to be satisfied at the second time point.

19. The plant management system comprising:
the growth state estimation apparatus according to any one of claims 2, and wherein the processor:
controls environmental control equipment which controls environment in a plant factory, such that the growth state of the plant estimated by the processor becomes a predetermined growth state to be satisfied at the second time point, and
sends a message indicating abnormality occurrence in the environmental control equipment when the consumption amount of carbon dioxide identified by the processor is less than a predetermined threshold.

20. The plant management system comprising:
the growth state estimation apparatus according to any one of claims 3, and wherein the processor:
controls environmental control equipment which controls environment in a plant factory, such that the growth state of the plant estimated by the processor becomes a predetermined growth state to be satisfied at the second time point, and
sends a message indicating abnormality occurrence in the environmental control equipment when the consumption amount of carbon dioxide identified by the processor is less than a predetermined threshold.
